(19) United States
(12) Patent Application Publication
(10) Pub. No.: US 2024/0144803 A1
(43) Pub. Date: May 2, 2024

(54) SENSOR DATA INDIVIDUALIZATION USING DEFINED AND LEARNED REGION DATA

(71) Applicant: ResMed Inc., San Diego, CA (US)

(72) Inventors: Sean Robert COYER, San Mateo, CA (US); Jose Ricardo DOS SANTOS, San Diego, CA (US)

(21) Appl. No.: 18/492,395

(22) Filed: Oct. 23, 2023

Related U.S. Application Data
(60) Provisional application No. 63/381,059, filed on Oct. 26, 2022.

(51) Int. Cl. G08B 21/04

(52) U.S. Cl. CPC G08B 21/0415; G08B 21/0469

(57) ABSTRACT

Techniques for improved sensor data processing are provided. Sensor data indicating presence of an individual in a physical space is received, and a defined set of regions of the physical space is identified. A first region, of the defined set of regions, where the individual is located is identified based on the sensor data. The sensor data is labeled with a user identifier, of a plurality of user identifiers associated with the physical space, based on the first region. One or more personal services are provided to the individual based on the user identifier.

### CROSS-REFERENCE TO RELATED APPLICATIONS

This application claims priority to U.S. Provisional Patent Application No. 63/381,059, filed Oct. 26, 2022, the entire content of which is incorporated herein by reference in its entirety.

### INTRODUCTION

Embodiments of the present disclosure relate to sensor data processing. More specifically, embodiments of the present disclosure relate to sensor data individualization.

In many healthcare settings, such as in residential care facilities (e.g., nursing homes) or in-home care settings (e.g., where users or patients receive healthcare services while residing in their own homes), a wide variety of user, patient, or resident characteristics are assessed and monitored in an effort to reduce or prevent worsening any resident's condition. Additionally, various service plans are often devised by clinicians or other healthcare providers in an effort to ameliorate any issues or concerns for the user. For example, service plans may be used to ensure that the user is able to remain at home safely (e.g., as opposed to being admitted to a hospital or nursing home). These services can include, for example, ensuring the patient is fed, uses the bathroom, moves around regularly, and the like. However, such service plans have a multitude of varying alternatives and options, and are tremendously complex to design. Without appropriate service planning, these problems can lead to clinically significant negative outcomes and complications.

Additionally, it is often difficult to know what services are needed or what actions patients are capable of performing without assistance. In conventional approaches, third parties (e.g., family members, friends, healthcare providers, and the like) often attempt to determine the patient's state and abilities based on general conversations and observations. However, these approaches frequently fail to accurately assess how the patient fares when alone, and whether they are performing the daily activities needed (such as eating) to ensure they remain healthy and safe at home.

Improved systems and techniques to automatically evaluate and identify patient abilities and needs are needed.

### SUMMARY

According to one embodiment presented in this disclosure, a method is provided. The method includes: receiving sensor data indicating presence of an individual in a physical space; identifying a defined set of regions of the physical space; identifying, based on the sensor data, a first region, of the defined set of regions, where the individual is located; labeling the sensor data with a user identifier, of a plurality of user identifiers associated with the physical space, based on the first region; and providing one or more personal services to the individual based on the user identifier.

According to one embodiment presented in this disclosure, a method is provided. The method includes: receiving historical sensor data indicating, for one or more prior times, presence of an individual in a first region of a physical space; learning a label for the first region based on the historical sensor data, comprising at least one of (i) labeling the first region using a first user identifier corresponding to a first user, or (ii) labeling the first region using an action identifier; receiving current sensor data indicating presence of an individual in the physical space; and in response to determining, based on the current sensor data, that the individual is in the first region, labeling the current sensor data with at least one of (i) the first user identifier or (ii) the action identifier.

Other embodiments presented in this disclosure provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example environment for sensor data collection and analysis.

FIG. 2 depicts an example workflow for evaluating sensor data to identify users and actions.

FIG. 3 depicts an example workflow for providing targeted services to users based on evaluated sensor data.

FIG. 4 depicts an example workflow for learning and defining regions of a physical space to facilitate sensor data evaluations.

FIG. 5 is a flow diagram depicting an example method for individualizing sensor data from a physical space.

FIG. 6 is a flow diagram depicting an example method for individualizing sensor data based on defined region data.

FIG. 7 is a flow diagram depicting an example method for providing targeted services based on sensor data.

FIG. 8 is a flow diagram depicting an example method for defining region information for a physical space.

FIG. 9 is a flow diagram depicting an example method for learning region information for a physical space.

FIG. 10 is a flow diagram depicting an example method for learning region information based on user movements.

FIG. 11 is a flow diagram depicting an example method for learning region information based on user actions.

FIG. 12 is a flow diagram depicting an example method for verifying and ingesting learned region information.

FIG. 13 is a flow diagram depicting an example method for providing services based on sensor data.

FIG. 14 is a flow diagram depicting an example method for learning region information based on sensor data.

FIG. 15 depicts an example computing device configured to perform various aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improved sensor data processing.

In some embodiments, a variety of sensors installed or otherwise present in a physical space can be used to collect information about the presence and/or movement of individuals in the space. Generally, the particular physical space(s) may differ, as may the particular sensor technologies, depending on the particular implementation. In some examples discussed herein, sensors are used to monitor the activities and movement of users (sometimes referred to as patients) in the space where they live (e.g., in their homes) in order to determine whether they can continue to remain in their homes (e.g., whether assistance services are needed or would be helpful, whether the user should move to a residential care facility, and the like). For example, the sensor data may be evaluated to determine whether they are performing their daily activities (e.g., using the bathroom, bathing, eating, and the like). Generally, aspects of the present disclosure can thereby improve the accuracy and reliability of user assessments, as well as improving their healthcare-related results (e.g., allowing them to live independently, while ensuring they do not suffer due to declining ability).

In some embodiments, radio detection and ranging (radar) sensors are used to detect the presence and/or movement of users. However, in embodiments, other sensors (such as ultrasonic sensors, imaging sensors, and the like) may similarly be used. Generally, any sensor capable of capturing or collecting data indicative of the presence and/or movement of individuals in a physical space can be used in embodiments of the present disclosure. In some embodiments, radar sensors offer a number of advantages which may facilitate various aspects of the present disclosure. For example, while some motion sensors can detect only motion or presence of an individual, radar sensors can further provide information relating to direction and velocity of the individual's movement, as well as orientation and positioning in the space. Further, in some embodiments, radar sensors can enable collection of more advanced vitals, such as breathing rate (e.g., based on detected movement of the individual's chest). Additionally, radar sensors can offer other benefits, such as enhanced privacy (e.g., as compared to imaging sensors), as well as the fact that the sensors themselves may be stationary and powered via wire (as opposed to wearable devices that must be remembered and charged).

In some physical spaces, the presence of multiple users can pose a substantial challenge to collecting and processing sensor data to identify user actions and movement. For example, if a married couple lives together in the space, sensors (such as radar sensors) may be used to identify the presence and movement of individuals generically, but conventionally cannot be used to determine the specific identity of each detected individual. For example, though the sensors may indicate that an individual used the bathroom at a given time, they are generally not able to indicate which user (of a set of multiple users in the home) corresponds to the detected individual. That is, conventional sensor-based approaches to monitor user actions are not able to individualize the data.

In embodiments of the present disclosure, techniques and systems are provided to enhance sensor data processing to enable individualization of the data. For example, using techniques described herein, the system can detect actions or movement of an individual (e.g., a human in a space), identify or infer the specific user (e.g., the name or other unique identifier) that performed the actions/corresponds to the detected individual, and/or identify or infer specific actions that were performed. This enables significantly improved sensor accuracy, enabling non-invasive and reliable monitoring even when multiple users reside in the environment and even with otherwise-limited sensor technologies.

In some embodiments, to provide such individualization, regions of the physical space are defined, where each region may be labeled with indication(s) of the corresponding user(s) associated with the region, and/or indication(s) of the corresponding action(s) associated with the region. For example, a given region (e.g., corresponding to one side of the bed in a bedroom) may be labeled to indicate which user is associated with the space (e.g., which user traditionally sleeps on that side of the bed). As users frequently have consistent relationships with specific regions in their homes (e.g., where a user may have an ordinary chair for meals or relaxation, which other users generally do not use), these region definitions can be reliably used to individualize detected movement. In an embodiment, when an individual is detected in a given region, the system can then automatically identify the corresponding (likely) user, and generate and/or store a record of this identification and movement/presence.

As another example, a given region (e.g., corresponding to a portion or corner of a bathroom) may be labeled to indicate which action(s) are associated with the space (e.g., actions generally performed in the region, such as bathing, using the toilet, and the like). As such actions are generally performed only in these designated regions (and other actions are generally not performed in these regions), these region definitions can be reliably used to individualize or identify/classify detected actions. In an embodiment, when an individual is detected in a given region, the system can then automatically identify the corresponding (likely) action, and generate and/or store a record of this identification and action.

In some embodiments, some or all of the region definitions may be manually specified. That is, a user (e.g., the users occupying the space, or a third party such as a relative, friend, or healthcare service provider) may define regions in the space (e.g., on a floor plan or three-dimensional model). The user may similarly specify the associated user(s) and/or action(s) for each such region. In some embodiments, some or all of the region definitions may be learned or inferred. That is, the system may automatically (or with assistance) learn or self-define regions in the space, and/or user/action identifications for the regions. For example, the system may define and label a region as the toilet based on determining that it is in a bathroom space, and that individuals enter the space, sit in the region, and then stand and leave the space. Similarly, based on the particular movements associated with bathing, the system may generate and label a region as the shower or bath, and based on the movements associated with sleep (e.g., laying down, followed by a detected breathing rate corresponding to sleep), the system may define a region as a portion of a bed where sleep actions are performed.

Relatedly, in some embodiments, the system can learn or infer specific users associated with given regions. For example, suppose a first region is already labeled with an indication of a specific user (e.g., the user's side of the bed). Suppose further that the system detects a user leaving this region (e.g., getting out of bed), entering a second region (e.g., sitting in a chair), and/or moving between the two regions according to some frequency or pattern criteria (e.g., daily, every morning, and the like). In some embodiments, the system may therefore generate and assign a label to the second region indicating that if an individual is detected in the region (in general, or at learned specific times, such as first thing in the morning), the individual is likely the specific user performing their ordinary routine.

In embodiments, using these defined and/or learned region definitions, the system can thereby provide accurate and reliable individualization of sensor data, enabling significantly improved and targeted user services and monitoring.

### Example Environment for Sensor Data Collection and Analysis

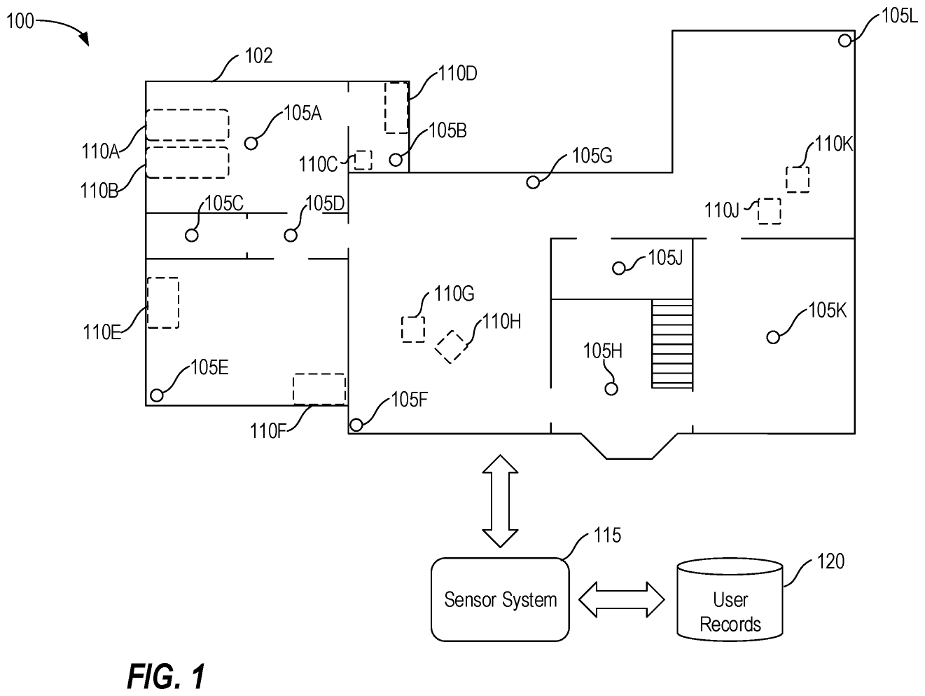

FIG. 1 depicts an example environment 100 for sensor data collection and analysis.

As illustrated, the environment 100 includes a physical space 102 (e.g., depicted as a floor plan of a home or other building), one or more sensors 105, a sensor system 115 (e.g., a computing device), and a set of user records 120. Although a single physical space 102 is depicted, there may be any number of physical spaces in the environment 100. In the illustrated example, the sensor system 115 is a discrete computing system. In embodiments, however, the sensor system 115 may be implemented as a standalone device or system, or as a component of a broader device or system. Further, the operations of the sensor system 115 may be implemented using hardware, software, or a combination of hardware and software, and may be distributed or combined across any number of devices and systems.

In some embodiments, the sensor system 115 corresponds to a computing device local to the physical space 102. For example, the sensor system 115 may be a laptop, desktop, or other device in the space and/or maintained by the user(s). In at least one embodiment, the sensor system 115 is a remote system (e.g., operating in a central location for any number of users across any number of physical spaces). In such embodiments, the sensors 105 may transmit their sensor data to the sensor system 115 via one or more networks, which may include wireless networks, wired networks, or a combination of wired and wireless networks. In at least one embodiment, the sensors 105 can transmit their collected data to the sensor system 115 by first transmitting it, via a local network (e.g., a WiFi network) to a wired or wireless access point and/or sensor hub, which then forwards the data over a broader network (e.g., the Internet) to the sensor system 115.

In the illustrated example, a number of sensors 105A-L (collectively, sensors 105) are configured in various locations in the physical space 105. In some embodiments, the sensors 105 are installed and/or configured by the user(s) occupying the space, or by a third party (e.g., a service provider) on behalf of the user(s). Generally, the sensors 105 may be arranged to collect sensor data relating to the positioning, presence, and/or movement of user(s) in one or more portions of the physical space 102. Generally, the particular number and arrangement of the sensors 105 may vary depending on the particular implementation and physical space 102. In some embodiments, some or all of the sensors 105 comprise radar sensors that collect radar data from the space. As discussed above, this radar sensor data can be used to identify the presence and/or movement of individuals in the space.

In the illustrated environment 100, the physical space 102 comprises a number of defined regions 110A-K (collectively, regions 110). Each region 110 generally corresponds to a portion or location in the physical space 102. For example, the regions 110 may each be defined using a set of coordinates indicating the boundaries of the location, using a coordinate of the center of the region 110, along with an associated shape and size of the region 110, and the like.

Generally, each region 110 can be labeled, tagged, or otherwise associated with one or more corresponding user identifiers (e.g., indicating the identity of the specific user associated with the region 110) and/or one or more action identifiers (e.g., indicating action(s) that are generally performed in the region 110). For example, the region 110A, which may correspond to one side of a bed, may be labeled with a first user identifier and a sleep action identifier. Using these tags, when an individual is detected in the region 110A (e.g., by the sensor 105A), the sensor system 115 may infer or determine that the individual corresponds to a first user associated with the first user identifier, and/or that the first user is sleeping.

In some embodiments, as discussed above and in more detail below, some or all of the regions 110 may be manually specified or defined. For example, the user(s) or a third party may generate or specify the boundaries of the region 110B, as well as labeling or indicating it as the side of the bed where a second user sleeps. Similarly, region 110E may be defined as the desk where a first user works, and region 110J may be defined as the kitchen chair that the first user prefers or uses. Generally, any number and variety of regions 110 may be similarly defined, such as by associating or tagging the specific user(s) and/or associating or selecting the specific action(s) (e.g., from a list of alternative actions).

In some embodiments, as discussed above and in more detail below, some or all of the regions 110 may be learned or inferred by the sensor system 115. For example, the sensor system 115 may learn or infer that the region 110C corresponds to a toilet (and, therefore, assign a toileting action identifier to the region 110C) based on determining that individuals enter the bathroom (as detected by the sensor 105B), perform a sitting action in the region 110C, and then leave the room. As another example, if the sensor system 115 detects an individual leaving the region 110A (which is assigned to the first user), and subsequently detects an individual entering and sitting in the region 110G, the sensor system 115 may learn or infer that the region 110G should be tagged with the first user identifier (e.g., if the user appears to routinely sit in the region 110G, other users do not appear to occupy the region 110G, and the like).

In some embodiments, the regions 110, once defined, may remain fixed. That is, the regions 110 may be manually specified and/or learned during a given period of time (e.g., a training or enrollment period), and then remain fixed during ordinary use (e.g., until the enrollment or learning period is re-enabled, or a user manually specifies a region definition). In other embodiments, the regions 110 may be continuously or periodically refined and learned (e.g., based on historical sensor data collected in the physical space 102), allowing the sensor system 115 to adjust dynamically to changing circumstances and routines of the users.

In the illustrated example, the sensor system 115 can access sensor data from the sensor(s) 105 continuously (e.g., as it is collected), periodically (e.g., where the data is provided every minute, every five minutes, and the like), or upon request (e.g., where the sensor system 115 pulls or requests the data). Generally, as used herein, “accessing” data can include receiving, requesting, retrieving, or otherwise gaining access to the data. In some embodiments, during runtime, the sensor system 115 evaluates the sensor data to identify action(s) and movement of one or more users associated with the physical space 102. This information can then be stored in the user record 120. Although depicted as residing separately from the sensor system 115, in some aspects, the user records 120 may generally be maintained in any suitable location (including locally within the sensor system 115).

In an embodiment, the user records 120 generally indicate the movement and actions or behavior of the users. This may include, for example, generating a record for each identified action, along with an indication of the timing of the action (e.g., when it began, when it ended, and/or its duration), the user that performed the action (e.g., using a unique user identifier), and the like. For example, the sensor system 115 may generate a user record 120 each time the user uses the bathroom in region 110C, each time the user bathes in region 110D, each time the user eats in region 110J or 110K, each time the user sleeps in region 110A or 110B, and the like.

In at least one embodiment, the sensor system 115 may additionally or alternatively generate aggregate user records 120. For example, the sensor system 115 may generate a record or other data indicating the total duration or amount of time (e.g., per day, per week, or per some other defined window) spent by each user performing one or more actions, the total or average number of times (e.g., per day, per week, or per some other defined window) the user performs one or more actions, the average or typical time or day when the user performs one or more actions, and the like.

In this way, the sensor system 115 (or another system) can readily review the user records 120 to determine whether any user(s) may be suffering from decline and/or need additional services. For example, based on determining that the number of times the user eats per day has been declining (or that the user is skipping meals), the sensor system 115 may determine that additional assistance (e.g., a dining service, a grocery shopping service, a meal preparation service, and the like) may be useful. Similarly, based on identifying changes such as that the average duration of sleep per day has decreased or that a defined number of days or hours have passed since the last recorded action (e.g., eating or using the bathroom), the sensor system 115 may determine that various other services or interventions are or may be appropriate.

### Example Workflow for Evaluating Sensor Data to Identify Users and Actions

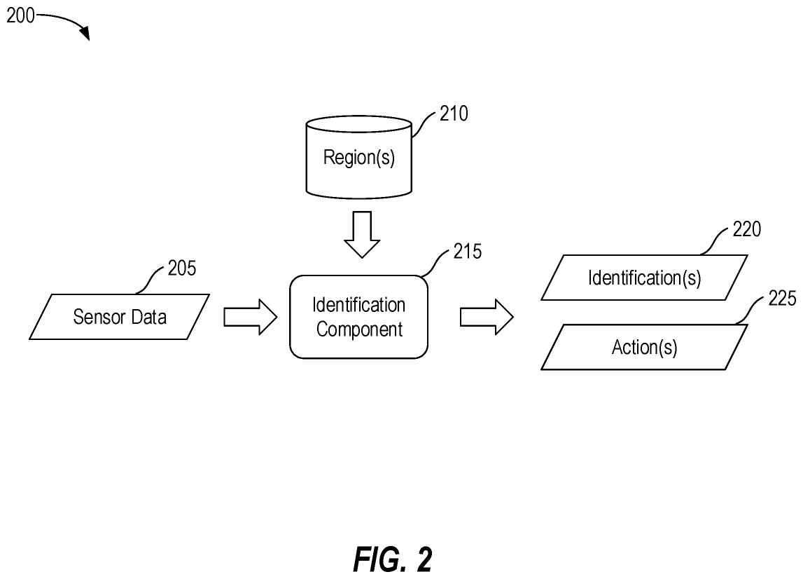

FIG. 2 depicts an example workflow 200 for evaluating sensor data to identify users and actions. In some embodiments, the workflow 200 may be performed using sensor data 205 collected using sensors (e.g., sensors 105 of FIG. 1) in a physical space (e.g., physical space 102 of FIG. 1). In at least one embodiment, the workflow 200 is performed by a sensor system (such as sensor system 115 of FIG. 1). For example, the identification component 215 may correspond to a component or portion of the sensor system.

In the illustrated workflow 200, sensor data 205 is accessed by an identification component 215. As discussed above, the sensor data 205 may be collected and/or provided by any number and type of sensors, and can generally indicate the detection, presence, and/or movement of individuals in a physical space. For example, the sensor data 205 may correspond to radar data collected by radar sensors. In embodiments, as discussed above, the sensor data 205 may be accessed or received continuously (e.g., as it is generated or collected), periodically, and the like. Generally, the identification component 215 may access the sensor data 205 using any suitable techniques or technologies. For example, the sensor data 205 may be transmitted, from the sensors, to the identification component 215 via one or more networks (such as the Internet), may be accessed or retrieved using one or more application programming interfaces (APIs), and the like. In some embodiments, the sensor data 205 includes discrete records or data (e.g., where each sensor reports detected motion or presence events as discrete records). In some embodiments, the sensor data 205 includes continuous data (e.g., continuous measurements from each sensor).

In the illustrated example, the identification component 215 uses the sensor data 205, along with definitions of regions 210, to generate identifications 220 and actions 225. Although depicted as a discrete component for conceptual clarity, in embodiments, the identification component 215 may be implemented as a standalone device or system, or as a component of a broader device or system. Further, the operations of the identification component 215 may be implemented using hardware, software, or a combination of hardware and software, and may be distributed or combined across any number of devices and systems.

In an embodiment, each region 210 generally corresponds to a designated or defined physical areas or locations in the physical space (e.g., the left side of the bed, a chair in the living room, and the like). As discussed above, these regions may be manually defined (e.g., drawn on a floorplan by a user) and/or may be learned or inferred (e.g., based on determining that one or more users generally or routinely occupy the region and/or perform one or more actions in the region). In some embodiments, each region 210 can also have a corresponding label or tag indicating one or more corresponding users for the region 210, one or more corresponding actions for the region, or both user(s) and action(s) for the region.

In the illustrated workflow 200, the identification component 215 can evaluate the sensor data 205 to identify the location(s) of any detected individual(s) in the space, and determine which region(s) 210, if any, these locations correspond to. For example, in response to determining that an individual was detected at a given coordinate or position in a house, the identification component 215 can determine whether this location corresponds to a defined region 210. If so, the identification component 215 may access or determine the corresponding user identifier(s) (e.g., to generate the identification(s) 220) and/or action identifier(s) (e.g., to generate the action(s) 225). That is, in response to determining that an individual is in a given region, the identification component 215 can generate and output corresponding identifications 220 and actions 225 that match the labels or tags associated with the region 210.

In an embodiment, these identifications 220 and actions 225 can then be used in a variety of ways. For example, they can be used to generate records of user movement and actions (e.g., user records 120 of FIG. 1), to facilitate provisioning of appropriate or needed services, to generate alerts or notifications to interested caregivers or third parties, and the like.

Example Workflow for Providing Targeted Services to Users based on Evaluated Sensor Data

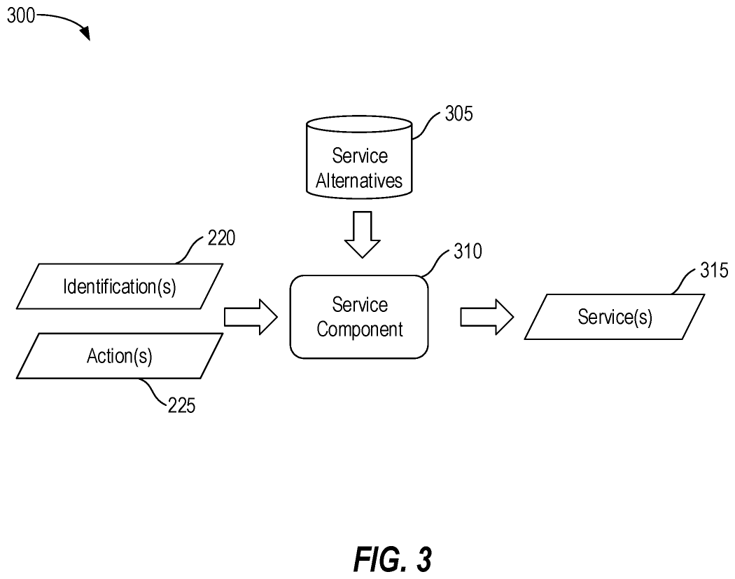

FIG. 3 depicts an example workflow 300 for providing targeted services to users based on evaluated sensor data. In some embodiments, the workflow 300 may be performed using identifications 220 and/or actions 225 (which may be generated using the workflow 200 of FIG. 2), which are generated based on detected individuals in a physical space (e.g., physical space 102 of FIG. 1). In at least one embodiment, the workflow 300 is performed by a sensor system (such as sensor system 115 of FIG. 1). For example, the service component 310 may correspond to a component or portion of the sensor system.

In the illustrated workflow 300, identification(s) 220 and/or action(s) 225 are accessed by a service component 310. As discussed above, the identification(s) 220 may generally indicate one or more specific users, such as using a unique user identifier, that were detected in specific locations of the physical space (e.g., because an individual was detected in a region that corresponds to the user). Similarly, the action(s) 225 may generally indicate one or more specific actions, such as bathing or eating, that were detected in the physical space (e.g., because an individual was detected in a region labeled with the action, and/or because the sensor data itself indicates the action, such as sleeping). Although the illustrated example depicts the service component 310 receiving both identifications 220 and actions 225, in some embodiments, the workflow 300 may be performed using only the identifications 220 (without actions 225), only the actions 225 (without identifications 220), or using both identifications 220 and actions 225.

In the illustrated example, the service component 310 uses the identifications 220 and/or actions 225, along with definitions of service alternatives 305, to generate and/or suggest services 315 for the user(s). Although depicted as a discrete component for conceptual clarity, in embodiments, the service component 310 may be implemented as a standalone device or system, or as a component of a broader device or system. Further, the operations of the service component 310 may be implemented using hardware, software, or a combination of hardware and software, and may be distributed or combined across any number of devices and systems.

In an embodiment, the service alternatives 305 generally indicate potential services, assistances, or other interventions that may be available to assist user(s) in the space. For example, the alternative services 305 may include options such as bathroom assistance, cleaning assistance, meal preparation and/or consumption assistance, bathing assistance, and the like. Generally, the service alternatives 305 can correspond to any action or intervention (including in-home care or moving to a residential facility) for users.

In the illustrated workflow 300, the service component 310 can evaluate the identification(s) 220 and/or action(s) 225 to identify whether one or more users in the space (e.g., indicated in the identifications 220) could benefit from one or more service alternatives 305. In some embodiments, the service component 310 identifies potentially-relevant service alternatives 305 for the user(s) based on defined mappings between user identifiers and/or user action(s) and the service alternative(s) 305. For example, a service alternative 305 such as meal preparation may be relevant or mapped to an action 225 such as eating.

Generally, the services 315 are generated or suggested to remedy any concerns reflected in the identification(s) 220 and/or action(s) 225. In at least one embodiment, determining whether to suggest a given service 315 is performed based on defined criteria. For example, some actions may be associated with a preferred, minimum, and/or maximum frequency (e.g., times per day, per week, and the like) and/or duration, which may be specified by the users themselves and/or by third parties (e.g., by healthcare professionals). In an embodiment, if the generated identification(s) 220 and corresponding action(s) 225 do not satisfy these criteria, the service component 310 may determine that one or more corresponding services 315 should be suggested.

In some embodiments, the service criteria includes time-based or change-based criteria. That is, the service component 310 may monitor how the detected action(s) 225, with respect to a given user, have changed over time. For example, the service component 310 may determine whether the frequency and/or duration of performing one or more action(s) 225 has increased or decreased beyond a threshold value or percentile. If so, one or more services 315 may be appropriate.

In some embodiments, the service component 310 can suggest the services 315 to the user or a third party. This user can then review and approve or decline each. In at least one embodiment, the service component 310 can automatically instantiate or begin providing one or more of the services 315. For example, in response to determining that the user has not left their bed all day, the service component 310 may immediately instantiate an alert service to dispatch assistance to the physical space. In this way, the service component 310 can significantly improve user outcomes.

### Example Workflow for Learning and Defining Regions of a Physical Space to Facilitate Sensor Data Evaluations

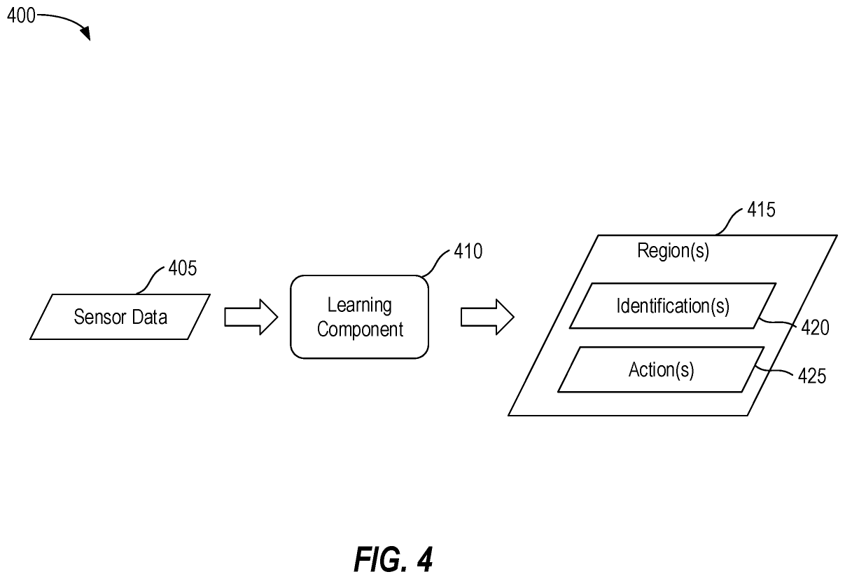

FIG. 4 depicts an example workflow 400 for learning and defining regions of a physical space to facilitate sensor data evaluations. In some embodiments, the workflow 400 may be performed using sensor data 405 (which may correspond to sensor data 205 of FIG. 2) collected using sensors (e.g., sensors 105 of FIG. 1) in a physical space (e.g., physical space 102 of FIG. 1). In at least one embodiment, the workflow 400 is performed by a sensor system (such as sensor system 115 of FIG. 1). For example, the learning component 410 may correspond to a component or portion of the sensor system.

In the illustrated workflow 400, sensor data 405 is accessed by a learning component 410. As discussed above, the sensor data 405 may be collected and/or provided by any number and type of sensors, and can generally indicate the detection, presence, and/or movement of individuals in a physical space. For example, the sensor data 405 may correspond to radar data collected by radar sensors.

In the illustrated example, the learning component 410 uses the sensor data 405 to generate one or more definitions of regions 415, each having one or more identifications 420 and/or one or more actions 425. Although depicted as a discrete component for conceptual clarity, in embodiments, the learning component 410 may be implemented as a standalone device or system, or as a component of a broader device or system. Further, the operations of the learning component 410 may be implemented using hardware, software, or a combination of hardware and software, and may be distributed or combined across any number of devices and systems.

In some embodiments, the sensor data 405 is historical data (e.g., data collected over a period of time, such as over the last week, during an enrollment or initial phase of deploying the sensor system, and the like). In an embodiment, the learning component 410 can evaluate the sensor data 405 to identify where individual(s) are detected in the space and/or the patterns or routines of these movements in order to define new regions 415 and/or update labels for existing regions 415.

In some embodiments, to generate a new region 415 and/or assign a new identification 420 to a region 415, the learning component 410 can evaluate routines and/or movement of the detected individuals to identify specific users. For example, if an individual is detected leaving a first region (having a known identification or user association with a first user) and entering a second area, the learning component 410 may generate a new region 415 for this second location and/or assign a new identification 420 for the first user to an existing region for the second area.

In some embodiments, this labeling is performed upon determining that the sensor data 405 satisfies defined criteria. For example, the learning component 410 may determine whether the detected movement (from the first region to the second) is performed with a sufficient frequency (e.g., a defined number of times per day), whether other individuals are ever associated or identified in the second region (e.g., using similar movement-based techniques to track other users), and the like. Upon determining that the second region is sufficiently linked to or associated with the first user, the learning component 410 can generate an identification 420 indicating that the user identity of the first user is associated with the region 415.

Of course, though detecting movement of individuals from (known or labeled) first regions to (unknown or unlabeled) second regions is used as one example technique to learn associations between users and regions, in embodiments, the learning component 410 may use a variety of other techniques depending on the particular implementation. For example, in some embodiments, the learning component 410 may identify or infer the associations based on relative size of the detected individuals (e.g., where the sensor data 405 is sufficiently granular to correlate the detected individuals to specific users), based on detected gaits or movement patterns (e.g., walking patterns of the users), and the like.

In some embodiments, to generate a new region 415 and/or assign a new action 425 to a region, the learning component 410 can evaluate routines or patterns of the detected individuals (with or without reference to the specific identity of the users). In one such embodiment, the learning component 410 may use a rules-based approach to determine or infer that specific actions are being performed in specific regions, based on the sensor data 405. For example, if the learning component 410 determines that individuals detected by a specific sensor in a bathroom (e.g., where the sensor is labeled or configured as a bathroom-placed sensor during installation or configuration), where the users frequently enter and immediately sit in the same region or portion of the space for some time, the learning component 410 may determine or infer that the identified location in the space is a toilet. In response, the learning component 410 may generate a new region 415 corresponding to this location, including an action 425 indicating use of a toilet.

In some embodiments, as discussed above, this labeling is similarly performed upon determining that the sensor data 405 satisfies defined criteria. For example, the learning component 410 may determine whether the detected actions (in the specific region) are performed with a sufficient frequency (e.g., a defined number of times per day), whether other action(s) are ever performed in the region, and the like. Upon determining that the region is sufficiently linked to or associated with the action(s), the learning component 410 can generate an action 425 indicating that the action identity of the detected action is associated with the region 415.

Though the illustrated example depicts assigning both identifications 420 and actions 425 to a region 415, in embodiments, the sensor system may assign only identifications 420, only actions 425, or both identifications and actions to any given region 415.

In this way, the learning component 410 can dynamically learn to define new regions 415 based on historical sensor data 405. These new regions 415 can then be used to help improve future user individualization and/or action identification, as discussed above.

### Example Method for Individualizing Sensor Data from a Physical Space

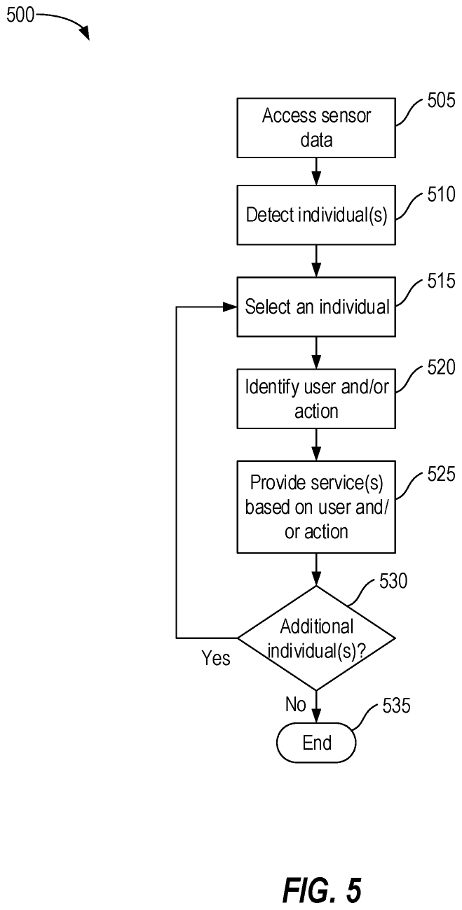

FIG. 5 is a flow diagram depicting an example method 500 for individualizing sensor data from a physical space. In at least one embodiment, the method 500 is performed by a sensor system (such as sensor system 115 of FIG. 1). For example, the method 500 may be performed by an identification component (e.g., identification component 215 of FIG. 2) of a sensor system.

At block 505, the sensor system accesses sensor data. As discussed above, the sensor data may generally indicate or include information relating to the presence, movement, and/or orientation of one or more individuals in a physical space. For example, the sensor data may indicate the number of detected individuals, the location of each in the space, the orientation of each (e.g., seated or standing) in the space, action(s) being performed by each (such as their walking speed, whether they are using their hands to perform an action, and the like), their breathing rates, and the like. In at least one embodiment, the sensor data is captured using one or more radar sensors in the space.

In some embodiments, accessing the sensor data includes receiving it (e.g., from the sensor components) as it is generated. That is, the sensors may transmit or otherwise provide the sensor data continuously (in real-time or near real-time). In some embodiments, the sensor data is received in batches periodically (e.g., receiving the data from a given window, such as every five minutes, every hour, or every day, at the end of the given window).

At block 510, the sensor system detects, identifies, or otherwise determines a set of one or more individuals in the physical space, as reflected in the sensor data. As discussed above, in some embodiments, the sensor data can explicitly indicate the individuals and locations. In other embodiments, the sensor data may be raw radar data, and the sensor system (or another component) may analyze this data to identify the individuals. Although the illustrated example indicates detection of one or more individuals, in some aspects, the sensor data may not reflect any individuals (e.g., no individuals may be in the space). In one embodiment, if no individuals are detected, the method 500 can terminate or return to block 505 to access the next set of sensor data.

At block 515, the sensor system selects one of the detected individuals (also referred to as one of the detections) in the sensor data. Generally, the sensor system may use any suitable technique to select the detection, including randomly or pseudo-randomly, as each detection will be processed during the method 500. As discussed above, each detection or detected individual may generally correspond to an instance of a user being present in the physical space. However, in some aspects, the user may not be identifiable from the sensor data. For example, though the sensor data may enable differentiation between two users of substantially different heights or sizes, it may be insufficiently granular to differentiate between similarly-sized users. Similarly, in some embodiments, the sensor data may be unable to differentiate between users of the system (e.g., the individuals who occupy or live in the space, whose actions are being monitored) and other third parties (e.g., caregivers, relatives, or friends who visit the space, but whose actions are not of importance to the sensor system).

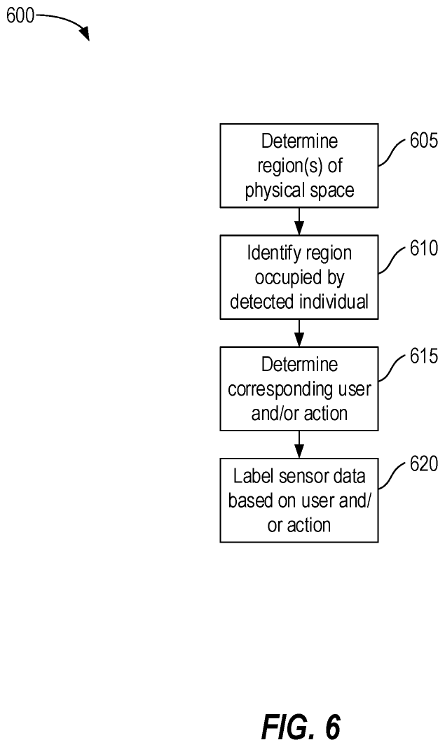

At block 520, the sensor system identifies the user that corresponds to the selected individual (e.g., the user depicted or corresponding to the selected detection) and/or determines the action(s) being performed by the user/detected individual. In some embodiments, as discussed above, the sensor system can identify the user and/or actions based at least in part on the region where the detected individual is located in the space. In some embodiments, identifying the user corresponds to identifying which user, from a defined set of users associated with the space (e.g., users who live in the house and/or may need assistance or monitoring), is represented by the detection. One example technique to identify the user and/or action is discussed below in more detail with reference to FIG. 6.

In some embodiments, if the user cannot be conclusively identified (or identified above a defined confidence), the sensor system can take a variety of actions, including discarding or ignoring the detection, flagging the detection for manual review (e.g., by the user(s) or a third party), and the like. For example, if the detection does not correspond to any of the defined regions used by the sensor system and cannot otherwise be identified (e.g., based on the size or gait of the user), the sensor system may refrain from labeling it or otherwise using it for further actions.

In at least one embodiment, as discussed below in more detail, the sensor system may infer the identity of the user based on movement between identified regions. For example, the sensor system may identify a first user based on determining they are in a first region and/or departing the region, then detect an unknown individual in a second region or portion of the space. In some embodiments, the sensor system may determine that the unknown individual is the first user based on the detected movement (e.g., leaving the first region). Similarly, in some embodiments, the sensor system may identify the user by process of elimination. For example, if two users are registered/associated with the sensor system for the physical space, and two individuals are reflected in the sensor data, the sensor system may determine whether either can be identified. If so, the identity of the other may be confirmed by process of elimination.

At block 525, the sensor system optionally provides one or more service(s) to the identified user based on the identification and/or based on the detected actions. In some embodiments, as discussed above, the sensor system may determine that the action(s) are being performed more or less frequently, by the user, as compared to a prior window, that the duration of time needed to complete the action(s) has increased (as compared to a prior window), that the user has not performed the action before (or has not done so for a defined length of time), and the like. For example, if the length of time the user needs to complete a bathing activity has increased, the sensor system may infer or determine that they may benefit from a bathing assistance service. Similarly, if the sensor system determines that they are getting up out of their favorite chair less frequently (e.g., they are spending more time in the chair), the sensor system may infer or determine that they have mobility issues and may benefit from mobility assistance. As another example, if the sensor system determines that they are sleeping more or less (e.g., going to bed earlier or later, and/or getting up earlier or later) than normal, the user may benefit from sleep interventions such as medication or other actions.

In some embodiments, providing the service can include suggesting it or outputting it to a user (e.g., the user who may receive the service, or a third party). For example, the sensor system may transmit a notification to the identified user indicating the detected concern(s) (e.g., noting “We noticed you have not been walking around as much” or “We noticed that your walking speed has slowed”), asking questions to determine more information (e.g., “Have you been experiencing increased pain lately?”) and/or offering one or more services for assistance (e.g., “Would you like assistance with getting up?” or “Would a walker or cane help you move around better?”). As discussed above, in some embodiments, the service(s) are identified based on defined mappings (e.g., rules) specifying (potentially) appropriate services or interventions based on detected user actions or changes.

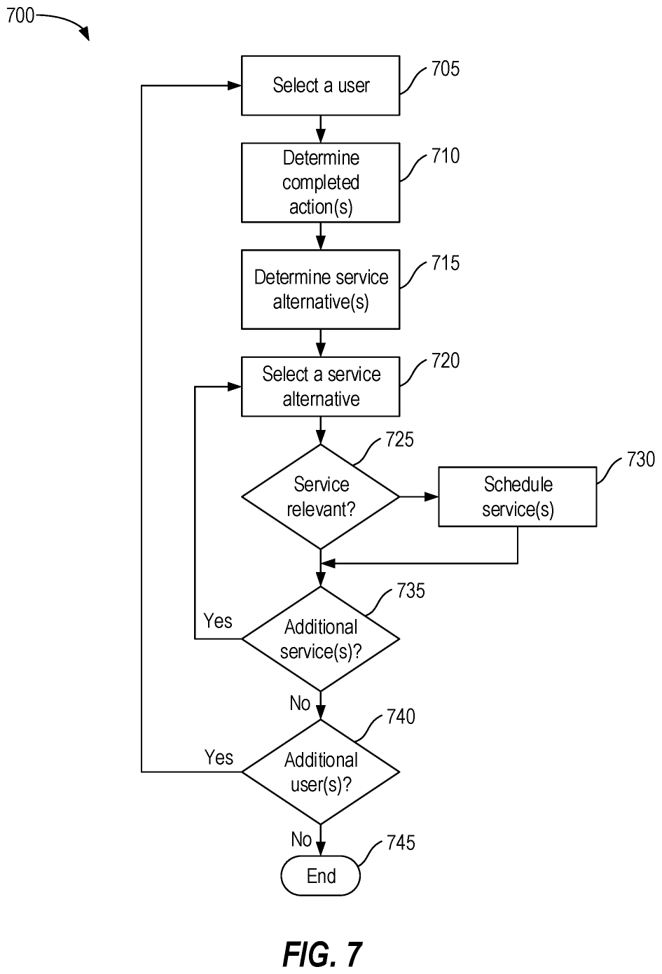

In some embodiments, providing the service can include automatically implementing it, such as by ordering or contracting with a caregiver or other assistance provider, or dispatching a third party to the space immediately or at a scheduled future time. One example technique for identifying and/or providing services is discussed in more detail below with reference to FIG. 7.

At block 530, the sensor system determines whether there is at least one additional individual detected in the sensor data. If so, the method returns to block 515. If not, the method 500 terminates at block 535. Although the illustrated example depicts a sequential process for conceptual clarity (e.g., selecting and evaluating each detection in turn), in some aspects, some or all of the detections may be processed in parallel.

Using the method 500, the sensor system can therefore provide dynamic and targeted monitoring and individualization of the sensor data, significantly improving the functionality of such monitoring systems and adding additional capabilities to otherwise limited or restricted sensors. For example, radar sensors may be relatively more affordable (as compared to more complex imaging sensors), easier to install or work with, and/or more privacy-preserving than conventional approaches. Using the disclosed embodiments, such limited sensors can nevertheless provide accurate individualization.

Further, relatively simpler sensors (e.g., radar sensors) may generally produce less data (e.g., smaller amounts of data), as compared to more complex imaging approaches. By using radar sensors, the amount of data that must be recorded, stored, and/or transmitted (e.g., across a network) can be substantially reduced. This can enable accurate user monitoring with significantly reduced computational resources (e.g., less consumed bandwidth, less storage requirements, reduced memory needs, reduced processing time, and the like), as compared to conventional systems.

Additionally, as discussed above, the method 500 enables more targeted and dynamic interventions and assistance to users who may be in need. For example, the sensor system can automatically monitor whether users are continuing to perform their daily activities, whether any of these activities appear to be affected or declining by various concerns, and the like. In this way, user outcomes are significantly improved and potential harm is substantially reduced or eliminated.

### Example Method for Individualizing Sensor Data Based on Defined Region Data

FIG. 6 is a flow diagram depicting an example method 600 for individualizing sensor data based on defined region data. In at least one embodiment, the method 600 is performed by a sensor system (such as sensor system 115 of FIG. 1). For example, the method 600 may be performed by an identification component (e.g., identification component 215 of FIG. 2) of a sensor system. In one embodiment, the method 600 provides additional detail for block 520 of FIG. 5.

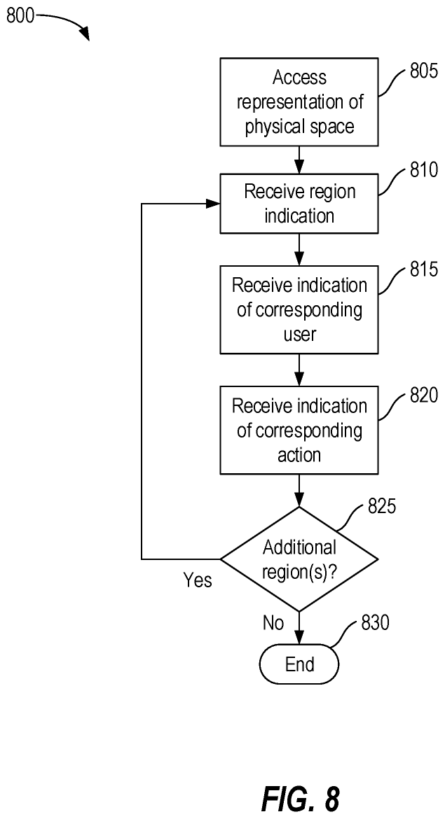

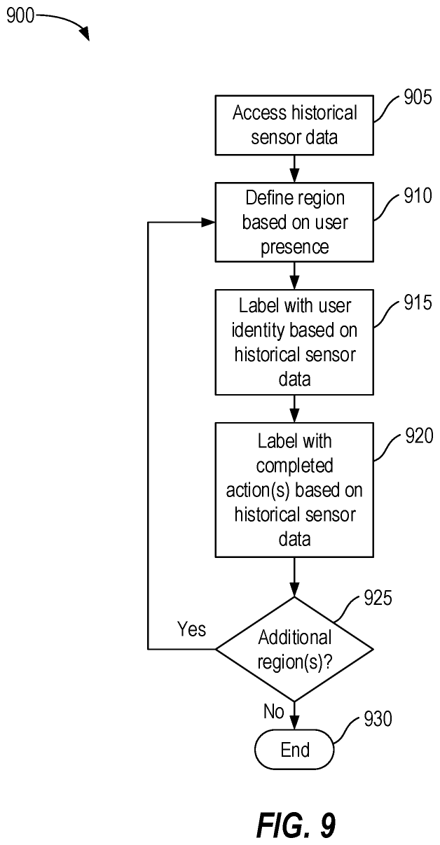

At block 605, the sensor system determines one or more defined regions of the physical space. As discussed above, determining the region(s) may generally include accessing a defined/stored set of regions, receiving user-defined regions, automatically generating and labeling regions, and the like. One example technique for generating user-defined regions is discussed in more detail below with reference to FIG. 8. Some example techniques for automatically defining regions without user specification are discussed in more detail below with reference to FIGS. 9, 10, and 11. As discussed above, each region in the set of defined regions generally includes or is associated with a physical location (or locations) in the space (e.g., a set of coordinates), zero or more user identifiers (e.g., indicating the user(s) that frequent the region), and zero or more action identifiers (e.g., indicating the action(s) that are frequently performed in the region).

At block 610, the sensor system identifies the region being occupied by a detected individual in the space based on their location. That is, the sensor system can compare the detected location of the individual to the location defined for each of the set of regions in order to identify which specific region the individual is occupying. In some embodiments, if no such region is identified (e.g., if the detected individual is not within one of the defined regions), the sensor system may discard or ignore the data, or may attempt to infer the user and/or actions using other techniques, as discussed above and below.

At block 615, the sensor system determines the corresponding user and/or action to assign to the detection, based on the identified region. For example, the sensor system may determine the user identifier associated with the region, and thereby determine or infer that the detected individual is the user associated with the user identifier. Similarly, the sensor system may determine the action identifier(s) associated with the region, and thereby determine or infer that the detected individual is performing the corresponding action(s).

At block 620, the sensor system can label the sensor data (e.g., a record of the data/detection) using the user identifier and/or action identifier(s), as appropriate. In some embodiments, this record can then be stored or otherwise used for further processing. For example, the sensor system (or another system) may review the records to determine how frequently each user performs various actions, how long the action(s) take to complete, and the like.

In this way, the sensor system can efficiently individualize the sensor data using reduced computational resources and improved accuracy, as compared to conventional systems.

### Example Method for Providing Targeted Services Based on Sensor Data

FIG. 7 is a flow diagram depicting an example method 700 for providing targeted services based on sensor data. In at least one embodiment, the method 700 is performed by a sensor system (such as sensor system 115 of FIG. 1). For example, the method 700 may be performed by a service component (e.g., service component 310 of FIG. 3) of a sensor system. In one embodiment, the method 700 provides additional detail for block 525 of FIG. 5.

At block 705, the sensor system selects a user associated with a given physical space. That is, the sensor system can select a user, registered with or otherwise entered into the system, who is being monitored by the system (e.g., to determine what assistance is needed, to determine whether they can remain in their home, and the like). Generally, the sensor system may use any suitable technique to select the user, including randomly or pseudo-randomly, as each user will be processed during the method 700. In some embodiments, the sensor system selects the user from a set of users that are assigned to or associated with a given physical space. In some embodiments, the sensor system can select from a broader set of users (e.g., all users in a geographical region, all users associated with or served by a third party, and the like).

At block 710, the sensor system determines completed action(s) for the selected user during a window of time. For example, the sensor system may determine the set of action(s) the user performed during the last day, the last week, and the like. In some embodiments, as discussed above, determining the set of actions can include accessing and evaluating action records that are automatically generated based on sensor data. For example, using sensor data, the sensor system may generate and store records indicating that a specific user performed a specific action at a specific time, in a specific region, and/or for a specific duration.

In some embodiments, determining the actions can include not only determining the set of actions performed (e.g., where each record corresponds to a single instance or performance of an action), but also determining one or more aggregated action details. For example, the sensor system may determine, for one or more action identifiers, an action frequency (e.g., the average number of times per day the user performs the action, the average time that elapses between performances of the action, and the like), an action duration (e.g., the average or median time that elapses while the user performs the action), the amount of time that has elapsed since the last time the action was completed (whether within the current window or not), and the like.

At block 715, the sensor system determines a set of service alternatives that may be provided. As discussed above, the service alternatives generally correspond to a set of services (such as assistance options) that may be offered or provided to the user, if needed or desired. For example, the set of service alternatives may include services such as bathing assistance, meal preparation, mobility assistance, medication assistance, and the like. In some embodiments, the set of service alternatives are user-specific (e.g., where each user has a defined set of services they may desire or use). In other embodiments, the set of service alternatives may be generic (e.g., where any service can be used for any user, if needed or desired).

At block 720, the sensor system selects a service alternative from the set of service alternatives. Generally, the sensor system may use any suitable technique to select the service alternative, including randomly or pseudo-randomly, as each will be processed during the method 700.

At block 725, the sensor system determines whether the selected service is potentially relevant for the user (e.g., whether it may be needed or useful for the user) based on the completed actions. For example, for a bathing service, the sensor system may identify the corresponding or indicated action identifiers (e.g., actions implicated by or otherwise relevant to the bathing service), such as bathing or showering actions. The sensor system can then evaluate the determined completed actions for the user (which may include evaluating the records individually and/or evaluating the aggregate information) using one or more defined rules to determine whether the selected service is useful. For example, the rule(s) may specify that the service may be useful if the action frequency is below a defined amount and/or has decreased by a defined percentile, if the action duration has increased above a defined maximum and/or has increased above a defined percentile, and the like.

If, at block 725, the sensor system determines that the service is not relevant (e.g., the user does not appear to need the corresponding assistance), the method 700 continues to block 735. If, at block 725, the sensor system determines that the service is potentially relevant, the method 700 continues to block 730 where the sensor system schedules the services. That is, the sensor system may automatically engage or schedule the indicated services, such as by scheduling delivery of one or more needed items, instructing a caregiver to attend to the user, and the like. Although the illustrated example depicts automatically scheduling the services, in some embodiments, the sensor system may additionally or alternatively suggest or recommend the services. For example, the sensor system may transmit a notification or message to the user and/or to a third party to inquire whether the service is desired. The method 700 then continues to block 735.

At block 735, the sensor system determines whether there is at least one additional service, from the set of service alternatives, that has not-yet been evaluated. If so, the method 700 returns to block 720. If not, the method 700 continues to block 740. Although the illustrated example depicts a sequential process for conceptual clarity (e.g., iteratively selecting and evaluating each service alternative in turn), in some embodiments, some or all of the service alternatives may be evaluated in parallel. Further, though the illustrated example depicts evaluating each service alternative to determine whether it is needed, in some embodiments, the sensor system can additionally or alternatively evaluate each action or action category (reflected in the completed actions) to determine whether one or more services may be needed.

At block 740, the sensor system determines whether there is at least one additional user, from the set of users that use the system, that has not-yet been evaluated. If so, the method 700 returns to block 705. If not, the method 700 terminates at block 745. Although the illustrated example depicts a sequential process for conceptual clarity (e.g., iteratively selecting and evaluating each user in turn), in some embodiments, some or all of the users may be evaluated in parallel.

In this way, the sensor system can provide dynamic and efficient monitoring and assistance of users in various physical spaces while maintaining user privacy, reducing computational expense, and generally improving the efficiency, accuracy, and functionality of the computing device(s) and the service provisioning.

### Example Method for Defining Region Information for a Physical Space

FIG. 8 is a flow diagram depicting an example method 800 for defining region information for a physical space. In at least one embodiment, the method 800 is performed by a sensor system (such as sensor system 115 of FIG. 1). For example, the method 800 may be performed by a learning component (e.g., learning component 410 of FIG. 4) of a sensor system. In one embodiment, the method 800 provides additional detail for block 605 of FIG. 6.

At block 805, the sensor system accesses a representation of the physical space for which user actions are to be monitored. For example, the sensor system may access or receive a floor plan of the space (e.g., of the user's home). At least one embodiment, the representation can further include or indicate the location(s) and/or configurations of the sensors (e.g., radar sensors) installed in the space. In another embodiment, the sensor locations may be manually specified by a user or third party.

At block 810, the sensor system receives an indication of a region in the physical space. For example, a user occupying the space or a third party (such as a caregiver, or the individual installing and configuring the sensor system for the user) may provide coordinate(s) indicating the center and/or borders of a region. In at least one embodiment, to facilitate input of the region indications, the sensor system (or another system) can output the representation of the physical space on a graphical user interface (GUI). For example, the sensor system may display the floorplan, allowing users to manually input the regions (e.g., to select or draw on the floor plan in order to specify the border of the region).

At block 815, the sensor system can request and/or receive an indication of one or more users that correspond to the region indicated at block 810. In one embodiment, after defining the region borders, the user may select or input the user identifier (e.g., from a list or set of users associated with the physical space) that should be used to label the region. For example, if the region corresponds to a first user's favorite chair (e.g., the chair in which the first user sits for meals or relaxation, which other users do not use or rarely use), the user may specify or identify the unique identifier of the first user. In this way, when an individual is subsequently detected in the region, the sensor system can determine or infer that the detected individual is the first user.

At block 820, the sensor system can request and/or receive an indication of one or more actions that correspond to the region indicated at block 810. In one embodiment, after defining the region borders, the user may select or input the action identifier (e.g., from a list or set of actions that are monitored in the physical space) that should be used to label the region. For example, if the region corresponds to a toilet (e.g., the chair in which the first user sits for meals or relaxation, which other users do not use or rarely use), the user may specify or identify an action identifier corresponding to dining, relaxing, and the like. In this way, when an individual is subsequently detected in the region, the sensor system can determine or infer that the detected individual is performing the indicated action(s).

At block 825, the sensor system determines whether there is at least one additional region to be defined. For example, the sensor system may ask the user whether they have completed the region definitions, whether they wish to define an additional region, and the like. Similarly, the sensor system may determine whether the user has indicated a desire to enter or add additional region(s). If so, the method 800 returns to block 810. If not, the method 800 terminates at block 830.

Although the illustrated example depicts receiving indications of both user(s) and action(s) for the newly-defined regions, in some embodiments, the sensor system may instead receive only a user identifier, only an action identifier, or neither. For example, sensor system may receive a specification of the user associated with the region, with no specific action indicated (e.g., because the action is not relevant to the intended purposes, because the action is not known, and the like). Similarly, the sensor system may receive a specification of the action associated with the region, with no specific user indicated (e.g., because the specific user is not relevant to the intended purposes, because multiple users perform the action in the region, such as a toileting action or a bathing action, and the like).

Further, in some embodiments, if the sensor system receives only the region's physical location (with no specified users or actions), the sensor system may determine to learn the corresponding user(s) and/or action(s). For example, a third party may generate a region for each chair around a dining table, and allow the sensor system to learn or determine a user label for each region (e.g., to determine which chair each user generally uses). This may allow the system to be configured or initiated more rapidly and with reduced interference to or input from the users who occupy the space. In at least one embodiment, the sensor system (or a user) may subsequently delete any unused region(s). For example, after an initial configuration time, the sensor system may determine that one or more of the regions are unused (e.g., no users sat in a given chair, or they did so sufficiently infrequently), and therefore suggest that the region be deleted.

### Example Method for Learning Region Information for a Physical Space

FIG. 9 is a flow diagram depicting an example method for learning region information for a physical space. In at least one embodiment, the method 900 is performed by a sensor system (such as sensor system 115 of FIG. 1). For example, the method 900 may be performed by a learning component (e.g., learning component 410 of FIG. 4) of a sensor system. In one embodiment, the method 900 provides additional detail for blocks 815 and/or 820 of FIG. 8.

At block 905, the sensor system accesses historical sensor data for a physical space. For example, the sensor system may access sensor data corresponding to one or more defined windows of time, such as during an enrollment or initial configuration period (e.g., beginning when the sensors are installed), during a defined period of time (e.g., the last week, the last month, the last year, and the like) which may or may not include the current time and/or current window, and the like. Generally, the historical sensor data corresponds to any data collected in the space in the past.

In some embodiments, the historical sensor data corresponds to the raw data captured by the sensors (e.g., unlabeled detections of individuals). In some embodiments, the historical sensor data corresponds to labeled records (e.g., generated by the sensor system) indicating, for one or more detections, a corresponding user and/or a corresponding action, as discussed above. In some embodiments, the historical sensor data can additionally or alternatively include aggregated information for one or more regions, users, and/or actions, as discussed above.

At block 910, the sensor system defines a region based on user presence, as reflected in the historical data. In at least one embodiment, the sensor system generates or defines the region in response to determining that individual(s) have been detected in the region at least a threshold number of times, at a threshold frequency (such as at least twice per day), and/or for a threshold average or total duration (e.g., for at least two hours per day). For example, the sensor system may determine that individuals (regardless of their specific identification) have spent, on average, eight hours a day laying horizontally in a given location. In response, the sensor system may define or generate a region definition that encompasses this location.

In some embodiments, at block 910, the sensor system can additionally or alternatively select or identify a previously-defined region. For example, as discussed above, a user may define the borders of a region without specifying user(s) or action(s). Additionally, in at least one embodiment, the sensor system can additionally or alternatively select a previously-defined region (which may include action and/or user definitions) to determine whether the user identifiers and/or action identifiers should be supplemented or corrected.

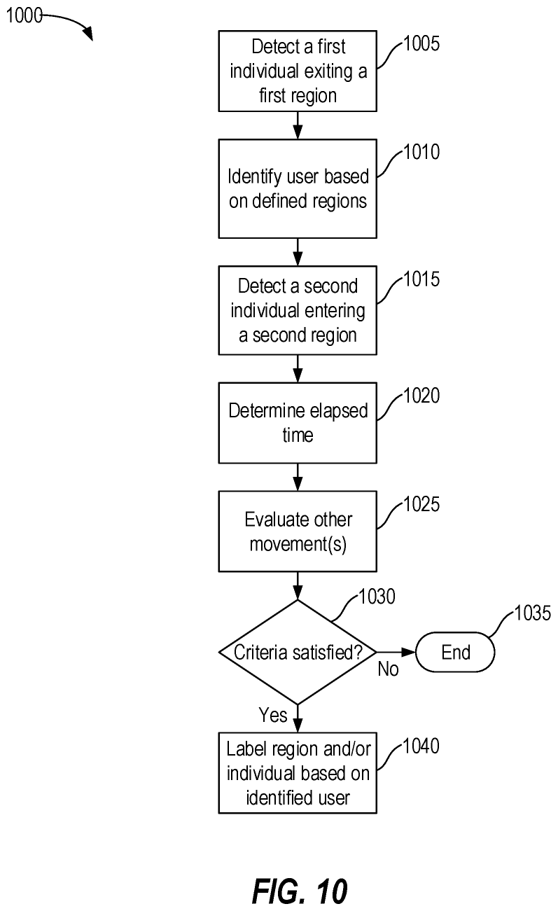

At block 915, the sensor system labels the region with a user identity for the region based on the historical sensor data. Generally, identifying the user identifier can be performed based on determining that the corresponding user has an association or link to the defined region. In some embodiments, the user identity or identities can be determined using various techniques, such as based on user movements, based on gait, based on size, and the like. One example technique for identifying users based on movement is discussed in more detail below with reference to FIG. 10. Once user(s) are identified, the sensor system can compare these identifications against presence criteria to determine whether the region should be labeled with any specific user identifier.

In some embodiments, the sensor system can identify this correlation based on determining whether a specific user was identified in the location or region at least a threshold number of times, a threshold frequency, for a threshold (average or total) duration of time, and the like. In some embodiments, the sensor system may additionally or alternatively determine whether any other users have a sufficiently strong link or association to the region. For example, if a first user has a sufficient association with the region (e.g., the user's historical data or movement satisfy the defined presence criteria), the sensor system may determine whether any other users have a sufficiently-strong association with the region (e.g., meeting the same presence criteria, or meeting relatively less-stringent criteria).

For example, if the sensor system determines that a first user is sufficiently-associated because they spend an average of five hours per day in the region, the sensor system may determine whether any other users spend a similar amount of time in the region (e.g., at least five hours), or spend a relatively lower amount of time (but still above a threshold, such as at least one hour per day).

In some embodiments, if any other user(s) are also related to the region above defined threshold criteria, the sensor system may determine that the region is not sufficiently linked to the first user such that it should be labeled with the first user's identifier (e.g., because it appears to be at least partially a shared region). However, in the illustrated example, if the sensor system determines that the space is sufficiently associated with a first user and/or is not sufficiently associated with any other users, the sensor system determines that the region should be labeled with the first user's identifier. That is, the sensor system determines that, if an individual is detected in the region, it is sufficiently likely that the individual is the first user (based on the presence criteria discussed above).

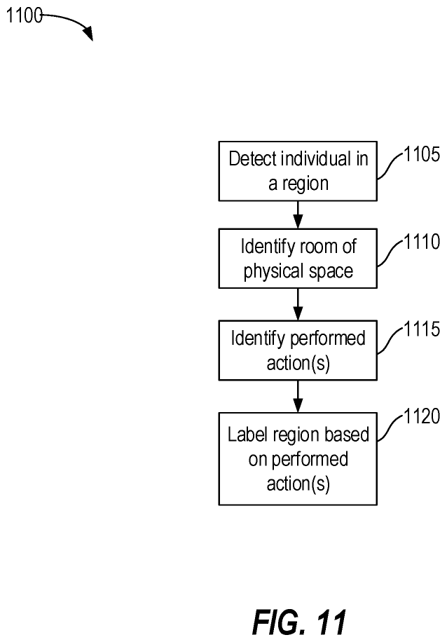

At block 920, the sensor system labels the region with one or more action identifiers for the region based on the historical sensor data. Generally, identifying the action identifier can be performed based on determining that the corresponding action has an association or link to the defined region. In some embodiments, the actions can be determined using various techniques, such as based on user movements, as reflected in the historical sensor data. One example technique for identifying actions based on movement is discussed in more detail below with reference to FIG. 11. Once action(s) are identified, the sensor system can compare these identifications against action criteria to determine whether the region should be labeled with any specific action identifier.

In some embodiments, the sensor system can identify this correlation based on determining whether a specific action was performed in the location or region at least a threshold number of times, a threshold frequency, for a threshold (average or total) duration of time, and the like. In some embodiments, the sensor system may additionally or alternatively determine whether any other actions have a sufficiently strong link or association to the region. For example, if a first action has a sufficient association with the region (e.g., the historical data or movement satisfy the defined action criteria), the sensor system may determine whether any other actions have a sufficiently-strong association with the region (e.g., meeting the same presence criteria, or meeting relatively less-stringent criteria).

For example, if the sensor system determines that a first action is sufficiently-associated because individuals spend an average of five hours per day in the region performing the action, the sensor system may determine whether any other actions are performed for a similar amount of time in the region (e.g., at least five hours), or for a relatively lower amount of time (but still above a threshold, such as at least one hour per day).

In some embodiments, if any other action(s) are also related to the region above defined threshold criteria, the sensor system may determine that the region is not sufficiently linked to the first action such that it should be labeled with the first action's identifier (e.g., because it appears to be a region where multiple actions are performed). However, in the illustrated example, if the sensor system determines that the space is sufficiently associated with a first action and/or is not sufficiently associated with any other actions, the sensor system determines that the region should be labeled with the first action's identifier. That is, the sensor system determines that, if an individual is detected in the region, it is sufficiently likely that the individual is performing the first action (based on the action criteria discussed above).

Although the illustrated example depicts labeling the region with indications of both user(s) and action(s), in some embodiments, the sensor system may instead label the region using only a user identifier, only an action identifier, or neither. For example, sensor system may determine that a specific user is sufficiently associated with the region, with no specific action being identified (e.g., because the action is not relevant to the intended purposes, because multiple actions are performed in the region, and the like). Similarly, the sensor system may determine that a specific action is associated with the region, with no specific user being identified (e.g., because the specific user is not relevant to the intended purposes, because multiple users perform the action in the region, such as a toileting action or a bathing action, and the like).

Further, in some embodiments, the sensor system may learn the defined region (at block 910) without learning or identifying any specific users or actions. For example, the sensor system may determine that the region appears to be relevant or commonly-used, but that there is insufficient information in the historical sensor data to conclusively label the region. In some embodiments, the sensor system may respond by outputting the region (e.g., to a user or a third party) requesting confirmation or input, or may determine to continue to examine newly-received data to label it subsequently. In other embodiments, the sensor system may discard the identified region (e.g., because it is not likely relevant or useful for individualizing sensor data, given that the historical data does not indicate a clear pattern).

At block 925, the sensor system determines whether there is at least one additional region remaining to be evaluated or defined. If so, the method 900 returns to block 910. If not, the method 900 terminates at block 930. Though the illustrated example depicts a sequential process for conceptual clarity (e.g., where each region is selected and evaluated in turn), in embodiments, the sensor system may process some or all of the regions in parallel.

### Example Method for Identifying Eligible Users and Generating Service Plans

FIG. 10 is a flow diagram depicting an example method 1000 for learning region information based on user movements. In at least one embodiment, the method 1000 is performed by a sensor system (such as sensor system 115 of FIG. 1). For example, the method 1000 may be performed by a learning component (e.g., learning component 410 of FIG. 4) of a sensor system. In one embodiment, the method 1000 provides additional detail for block 815 of FIG. 8 and/or block 915 of FIG. 9.

At block 1005, the sensor system detects a first individual exiting a first region based on sensor data. For example, the sensor system may determine that an individual was detected in the first region at a first time and that no individuals were detected in the first regions at a second (subsequent) time. As another example, the sensor system may determine that the individual left the first region based on determining that the detection (as indicated in the sensor data) depicts the individual moving across the region, out of the region, and/or into a neighboring region. For example, the sensor system may determine or detect that a first individual got out of a bed region.

At block 1010, the sensor system identifies a first user corresponding to the first individual based on a set of defined regions. In some embodiments, as discussed above, the sensor system can evaluate the stored definition of the first region to determine the user identifier used to tag or label the region. For example, the sensor system may determine the identity of the user associated with the specific side of the bed. In this way, the sensor system can determine which specific user exited the bed region.

At block 1015, the sensor system detects a second individual entering a second region based on sensor data. For example, the sensor system may determine that no individual was detected in the second region at a first time and that an individual was detected in the second region at a second (subsequent) time. As another example, the sensor system may determine that the second individual entered the second region based on determining that the detection (as indicated in the sensor data) depicts the individual entering the region. For example, the sensor system may determine or detect that a second individual entered a chair region.

At block 1020, the sensor system determines the time that elapsed between the first individual leaving the first region and the second individual entered the second region. For example, if this time is too short, the sensor system may infer that the second individual is not the same as the first individual, because there is not sufficient time for the same user to have traversed the distance between the regions. Similarly, if the time is too long, the sensor system may determine that no solid inference can be drawn, as the movement out of the first region is not sufficiently tied to the movement into the second region.

At block 1025, the sensor system can optionally evaluate other user movement in the space. For example, in addition to detecting the first individual leaving the first region, the sensor system may determine whether any other users in the space similarly left or exited other region(s). If not (e.g., if all other users are accounted for in other regions at the time the second individual entered the second region), the sensor system may infer that the second individual is the same user as the first individual. However, if any other users are not accounted for or similarly left a region before the second individual entered the second region, the sensor system may determine that no solid inference can be drawn.

At block 1030, the sensor system determines whether one or more movement criteria are satisfied by the detection of the second individual in the second region. For example, as discussed above, the sensor system may determine whether the elapsed time between the detections is within a defined range, whether other user(s) are at known positions or were also moving through the space, and the like.

If the criteria are not satisfied, the sensor system determines that the second region cannot be labeled based on the movement, and the method 1000 terminates at block 1035. If, at block 1030, the sensor system determines that the criteria are satisfied, the method 1000 continues to block 1040, where the sensor system labels the second region based on the user identity of the first user (identified at block 1010), and/or labels the second detection (determined at block 1015) with the user identity of the first user. In this way, the sensor system can not only infer which user corresponds to the second individual, but also learn which identifier should be used to tag the second region.

Although the illustrated example depicts labeling the second region based on a single detection of the individual in the second region, in some embodiments, the sensor system can additionally or alternatively evaluate aggregate criteria. For example, in response to determining that the movement criteria are satisfied (e.g., it is sufficiently-likely that the second individual is the first user), the sensor system may store a record indicating this potential label for the second region. Based on multiple subsequent detections, the sensor system may determine whether the second region is sufficiently-linked to the first user (e.g., above a threshold number or frequency of times), as discussed above.

In this way, the sensor system can generate additional labels for region(s) and/or detections more accurately, ensuring reduced unknowns and gaps in the sensor data records and a more complete understanding of the users' movements in the space. In an embodiment, the sensor system can then generate a user record describing the movement, as discussed above, and/or use the newly-labeled second region as one of the region definitions used to track and label subsequent user movement.

### Example Method for Learning Region Information Based on User Actions

FIG. 11 is a flow diagram depicting an example method 1100 for learning region information based on user actions. In at least one embodiment, the method 1100 is performed by a sensor system (such as sensor system 115 of FIG. 1). For example, the method 1100 may be performed by a learning component (e.g., learning component 410 of FIG. 4) of a sensor system. In one embodiment, the method 1100 provides additional detail for block 820 of FIG. 8 and/or block 920 of FIG. 9.

At block 1105, the sensor system detects an individual in a region of a physical space. In some embodiments, the region may be previously-defined (e.g., by a user, to indicate that the sensor system should seek to determine a label for it, or automatically by the sensor system, based on determining that it appears to be a relevant or useful region to individualize sensor data). In some embodiments, as discussed above, the sensor system previously determined that individuals are present in the region in a way that satisfies defined criteria, such as a minimum number or frequency of times, for a minimum duration, and the like.

At block 1110, the sensor system identifies the room or portion of the physical space which the region occupies. For example, in one embodiment, a user may label the region based on the room (e.g., to indicate that the region is in the bathroom, in the bedroom, in the kitchen, and the like). In at least one embodiment, the sensor system identifies the room of the detection based on the sensor device that detected the individual. For example, the sensor system may identify the specific sensor device that provided the sensor data, and identify the room based on a label or configuration of the sensor device (e.g., indicating which room it is installed in).

At block 1115, the sensor system identifies any action(s) performed in the region by the detected individual. Generally, the evaluated action(s) may vary depending on the particular implementation. For example, the sensor system may detect whether the individual sat for some period of time, whether the user was sleeping (e.g., based on chest movement or other movement), whether the user performed other actions (such as bathing) based on the movement detected in the sensor data, and the like.

At block 1120, the sensor system can then label the region based on the performed actions. In one embodiment, the sensor system labels the region based on defined rules or mappings. For example, the sensor system may determine that the room is a bathroom, and that individuals enter the region, sit, and subsequently stand and leave. In response, the sensor system can infer that the region corresponds to the toilet. Similarly, the sensor system may determine that the room is a bedroom, and that individuals enter the region, lay down, and sleep for a period of time before leaving. In response, the sensor system can infer that the region is the bed.

Although the illustrated example depicts labeling the region based on a single detection of the action in the region, in some embodiments, the sensor system can additionally or alternatively evaluate aggregate criteria. For example, in response to determining that the action was performed in the region, the sensor system may store a record indicating this potential label for the region. Based on multiple subsequent detections, the sensor system may determine whether the region is sufficiently-linked to the action (e.g., above a threshold number or frequency of times), as discussed above.

In this way, the sensor system can generate additional labels for region(s) and/or detections more accurately, ensuring reduced unknowns and gaps in the sensor data records and a more complete understanding of the users' movements in the space. In an embodiment, the sensor system can then generate a user record describing the action performed, as discussed above, and/or use the newly-labeled region as one of the region definitions used to track and label subsequent user movement.

### Example Method for Verifying and Ingesting Learned Region Information

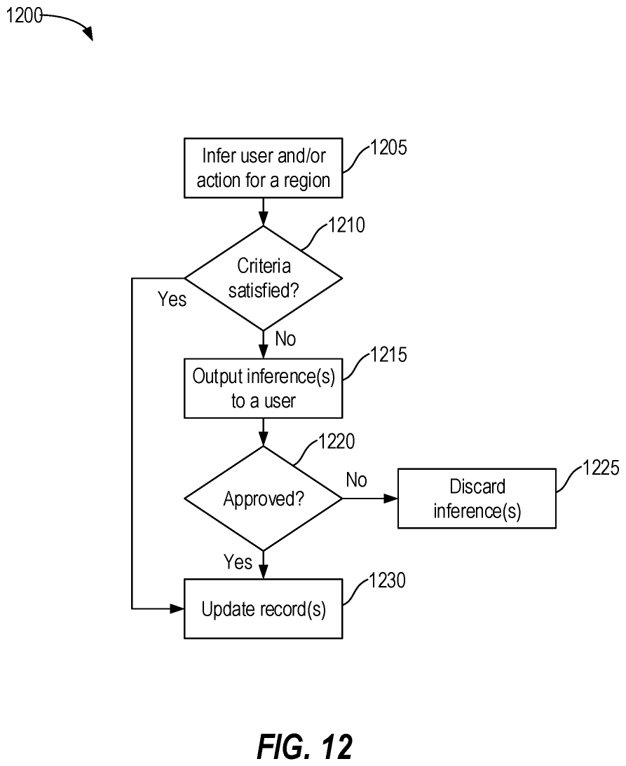

FIG. 12 is a flow diagram depicting an example method 1200 for verifying and ingesting learned region information. In at least one embodiment, the method 1200 is performed by a sensor system (such as sensor system 115 of FIG. 1). For example, the method 1200 may be performed by an identification component (e.g., identification component 215 of FIG. 2) of a sensor system and/or by a learning component (e.g., learning component 410 of FIG. 4) of a sensor system. In one embodiment, the method 1200 provides additional detail for block 520 of FIG. 5, block 620 of FIG. 6, blocks 915 and/or 920 of FIG. 9, block 1040 of FIG. 10, and/or block 1120 of FIG. 11.

At block 1205, the sensor system determines or infers a user identifier and/or action identifier for a given region. For example, as discussed above, the sensor system may identify the user identifier and/or action identifier based on a region definition (which may be user-specified or previously-learned by the system), based on user movement in the space, based on historical data, and the like. Generally, the sensor system may infer the identifiers during an enrollment phase (e.g., while the regions are being learned and the system is being configured) and/or during a runtime phase (e.g., where the regions are used to label user actions).

At block 1210, the sensor system determines whether one or more criteria are satisfied. Generally, the specific criteria may vary depending on the nature of the detection/inference at block 1205. Generally, at block 1210, the sensor system determines whether the inferred user and/or action are associated with sufficient confidence in the accuracy of the label.

For example, during enrollment or to learn a label for a region, the sensor system may determine whether the user's presence in the region satisfies defined criteria, whether other users are also present in the space from time-to-time, and the like. During runtime, the sensor system may determine whether the inference or label is associated with sufficient confidence. For example, the sensor system may determine a confidence that the individual is, in fact, in the region (e.g., as opposed to a nearby or neighboring region, or if the detected individual is on or near the border of the region), a confidence that the detection is of an individual in the first place (e.g., as opposed to a pet, or furniture or other items in the space), and the like.

In the illustrated example, if the confidence criteria are met, the method 1200 continues to block 1230, where the sensor system updates the system records based on the inference. For example, during training or enrollment, the sensor system can update the region records to label the given region with the inferred user and/or action label(s). During runtime, the sensor system can update the user or action records to label the detection/user data with the inferred user and/or action.

Returning to block 1210, if the sensor system determines that the criteria are not satisfied, the method 1200 continues to block 1215, where the sensor system outputs the inference(s) to one or more users (which may include the inferred user in the space and/or one or more third parties). For example, the sensor system may transmit, output, or display the region, inference, and/or sensor data, and ask the receiving user to confirm the inference. For example, during runtime, the sensor system may ask the user to confirm whether the detection corresponds to the inferred user, to confirm whether the individual is performing the confirmed action, and the like. During enrollment or training, the sensor system may similarly ask the user to confirm whether the detection corresponds to the inferred user, to confirm whether the individual is performing the confirmed action, to confirm whether the region should be linked or associated to the user, to confirm whether the region should be linked or associated to the action, and the like.

At block 1220, the sensor system determines whether the user approved the inference(s) as accurate. If so, the method 1200 continues to block 1230 to update the record(s) accordingly. If not, the method 1200 continues to block 1225, where the sensor system discards the inferences. That is, the sensor system can discard the sensor data and/or inferred identifiers, refraining from further processing of them (e.g., refraining from using them to label the data and/or region).

In this way, the sensor system can automatically perform labeling in many cases, while falling back to explicit user approval for some cases where the sensor system confidence does not meet defined thresholds.

### Example Method for Providing Services Based on Sensor Data

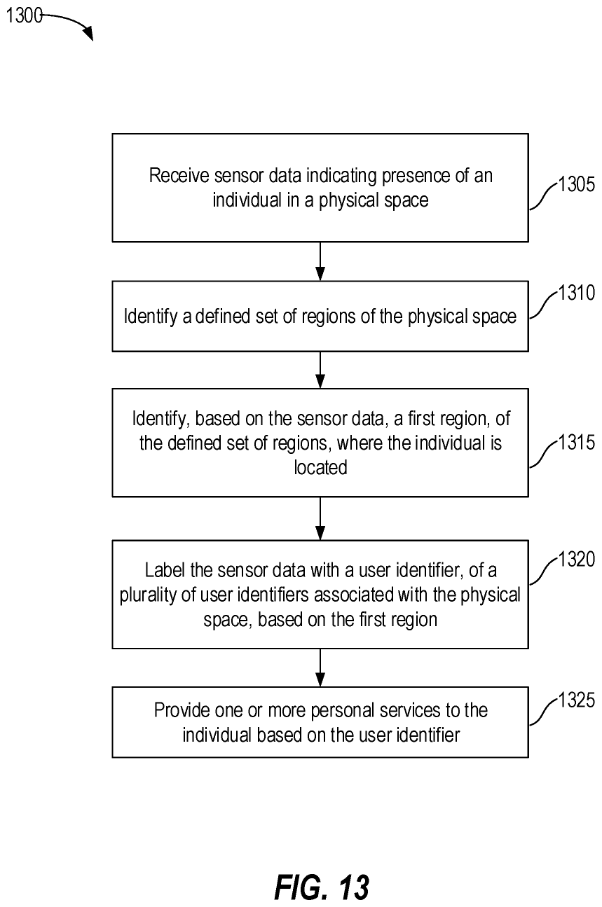

FIG. 13 is a flow diagram depicting an example method 1300 for providing services based on sensor data. In at least one embodiment, the method 1300 is performed by a sensor system (such as sensor system 115 of FIG. 1).

At block 1305, sensor data (e.g., sensor data 205 of FIG. 2) indicating presence of an individual in a physical space (e.g., physical space 102 of FIG. 1) is received.

At block 1310, a defined set of regions (e.g., regions 110 of FIG. 1 and/or regions 210 of FIG. 2) of the physical space is identified.

At block 1315, a first region, of the defined set of regions, where the individual is located is identified based on the sensor data.

At block 1320, the sensor data is labeled with a user identifier (e.g., identification 220 of FIG. 2), of a plurality of user identifiers associated with the physical space, based on the first region.

At block 1325, one or more personal services (e.g., services 315 of FIG. 3) are provided to the individual based on the user identifier.

### Example Method for Learning Region Information Based on Sensor Data

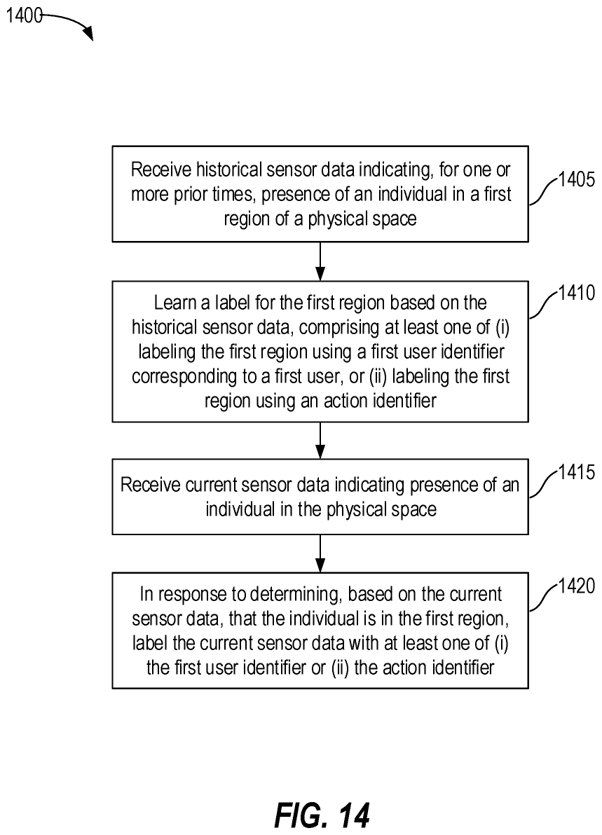

FIG. 14 is a flow diagram depicting an example method 1400 for learning region information based on sensor data. In at least one embodiment, the method 1400 is performed by a sensor system (such as sensor system 115 of FIG. 1).

At block 1405, historical sensor data (e.g., sensor data 405 of FIG. 4) indicating, for one or more prior times, presence of an individual in a first region of a physical space is received.

At block 1410, a label for the first region (e.g., region 415 of FIG. 4) is learned based on the historical sensor data, comprising at least one of (i) labeling the first region using a first user identifier corresponding to a first user (e.g., identification 420 of FIG. 4), or (ii) labeling the first region using an action identifier (e.g., action 425 of FIG. 4).

At block 1415, current sensor data (e.g., sensor data 205 of FIG. 2) indicating presence of an individual in the physical space is received.

At block 1420, in response to determining, based on the current sensor data, that the individual is in the first region, the current sensor data is labeled with at least one of (i) the first user identifier (e.g., identification 220 of FIG. 2) or (ii) the action identifier (e.g., action 225 of FIG. 2).

### Example Processing System for Improved Sensor Data

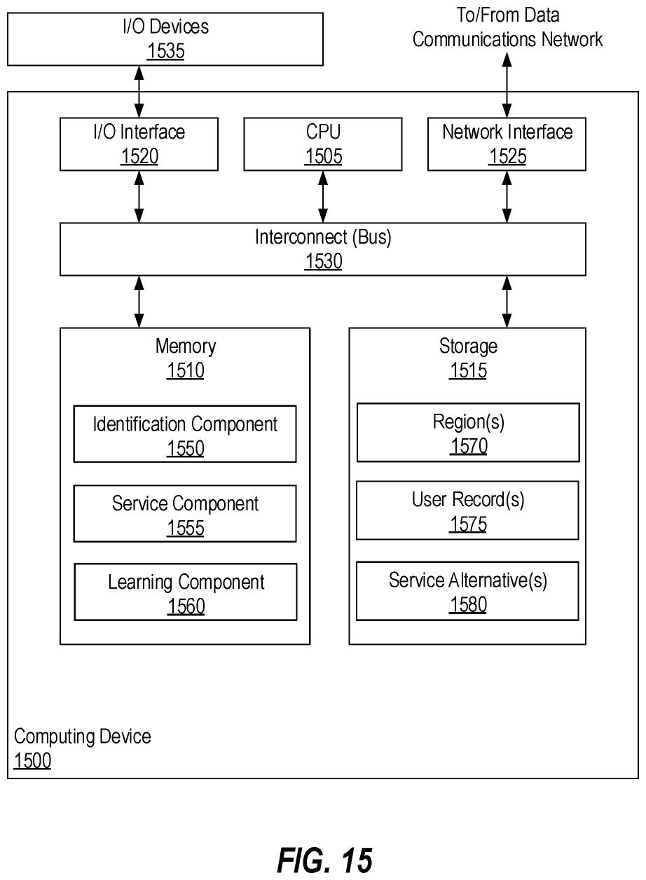

FIG. 15 depicts an example computing device 1500 configured to perform various aspects of the present disclosure. Although depicted as a physical device, in embodiments, the computing device 1500 may be implemented using virtual device(s), and/or across a number of devices (e.g., in a cloud environment). In one embodiment, the computing device 1500 corresponds to the sensor system 115 of FIG. 1.

As illustrated, the computing device 1500 includes a CPU 1505, memory 1510, storage 1515, a network interface 1525, and one or more I/O interfaces 1520. In the illustrated embodiment, the CPU 1505 retrieves and executes programming instructions stored in memory 1510, as well as stores and retrieves application data residing in storage 1515. The CPU 1505 is generally representative of a single CPU and/or GPU, multiple CPUs and/or GPUs, a single CPU and/or GPU having multiple processing cores, and the like. The memory 1510 is generally included to be representative of a random access memory. Storage 1515 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1535 (such as keyboards, monitors, etc.) are connected via the I/O interface(s) 1520. Further, via the network interface 1525, the computing device 1500 can be communicatively coupled with one or more other devices and components (e.g., via a network, which may include the Internet, local network(s), and the like). As illustrated, the CPU 1505, memory 1510, storage 1515, network interface(s) 1525, and I/O interface(s) 1520 are communicatively coupled by one or more buses 1530.

In the illustrated embodiment, the memory 1510 includes an identification component 1550, a service component 1555, and a learning component 1560, which may perform one or more embodiments discussed above. Although depicted as discrete components for conceptual clarity, in embodiments, the operations of the depicted components (and others not illustrated) may be combined or distributed across any number of components. Further, although depicted as software residing in memory 1510, in embodiments, the operations of the depicted components (and others not illustrated) may be implemented using hardware, software, or a combination of hardware and software.

In one embodiment, the identification component 1550 (which may correspond to the identification component 215 of FIG. 2) is used to determine or identify user identifiers and/or actions based on sensor data and defined regions (with corresponding labels), as discussed above. The service component 1555 (which may correspond to the service component 310 of FIG. 3) may generally be used to generate, identify, suggest, or otherwise facilitate provisioning of appropriate services for users based on the output of the identification component 1550, as discussed above. The learning component 1560 (which may correspond to the learning component 410 of FIG. 4) may be configured to learn or refine region definitions based on historical sensor data, such as to generate new regions and/or assign user(s) and/or action(s) to specific regions, as discussed above.

In the illustrated example, the storage 1515 includes region(s) 1570 (which may correspond to regions 210 of FIG. 2), as well as user record(s) 1575 (which may correspond to user records 120 of FIG. 1), and service alternative(s) 1580 (which may correspond to service alternatives 305 of FIG. 3). For example, the regions 1570 may be manually defined (e.g., by a user) and/or automatically generated/learned (e.g., by the learning component 1560), where each region generally has at least an associated location in the space (e.g., a set of coordinates), and may further have one or more labels or tags indicating corresponding user identifier(s) and/or action identifier(s). The user records 1575 may be generated by the identification component 1550, and generally include information relating to completed actions and movements of the users in the space. The service alternatives 1580 may generally correspond to a list or set of potential services, and may be used by the service component 1555 to improve user outcomes and service plans. Although depicted as residing in storage 1515, the regions 1570, user records 1575, and service alternatives 1580 may be stored in any suitable location, including memory 1510.

### Example Clauses

Implementation examples are described in the following numbered clauses:

Clause 1: A method, comprising: receiving sensor data indicating presence of an individual in a physical space; identifying a defined set of regions of the physical space; identifying, based on the sensor data, a first region, of the defined set of regions, where the individual is located; labeling the sensor data with a user identifier, of a plurality of user identifiers associated with the physical space, based on the first region; and providing one or more personal services to the individual based on the user identifier.

Clause 2: The method of Clause 1, wherein the sensor data comprises radar data collected using one or more radar sensors in the physical space.

Clause 3: The method of any one of Clauses 1-2, wherein the first region is labeled with the user identifier to indicate that a user corresponding to the user identifier is associated with the first region in the physical space.

Clause 4: The method of any one of Clauses 1-3, wherein identifying the defined set of regions comprises: identifying one or more manually defined regions in the physical space; and identifying, for each respective region of the one or more manually defined regions, a respective manually defined user identifier.

Clause 5: The method of any one of Clauses 1-4, wherein identifying the defined set of regions comprises, for at least one region of the defined set of regions, learning a user identifier associated with the at least one region based on historical sensor data for the physical space.

Clause 6: The method of any one of Clauses 1-5, further comprising assigning a completed action to a user corresponding to the user identifier based on the first region.

Clause 7: The method of any one of Clauses 1-6, wherein assigning the completed action to the user comprises identifying one or more action identifiers having a manually defined association with the first region.

Clause 8: The method of any one of Clauses 1-7, wherein assigning the completed action to the user comprises learning one or more action identifiers associated with the first region based on historical sensor data.

Clause 9: The method of any one of Clauses 1-8, wherein the one or more personal services comprise one or more healthcare-related services selected to allow the individual to reside in the physical space.

Clause 10: A method, comprising: receiving historical sensor data indicating, for one or more prior times, presence of an individual in a first region of a physical space; learning a label for the first region based on the historical sensor data, comprising at least one of (i) labeling the first region using a first user identifier corresponding to a first user, or (ii) labeling the first region using an action identifier; receiving current sensor data indicating presence of an individual in the physical space; and in response to determining, based on the current sensor data, that the individual is in the first region, labeling the current sensor data with at least one of (i) the first user identifier or (ii) the action identifier.

Clause 11: The method of Clause 10, wherein the historical sensor data and current sensor data comprise radar data collected using one or more radar sensors in the physical space.

Clause 12: The method of any one of Clauses 10-11, wherein learning the label for the first region comprises labeling the first region using the first user identifier in response to determining, based on the historical sensor data, that the first user has a stronger association with the first region, as compared to at least a second user.

Clause 13: The method of any one of Clauses 10-12, wherein determining that the first user has the stronger association comprises: determining, based on the historical sensor data, that an individual left a second region of the physical space at a first point in time, wherein the second region is labeled using the first user identifier; and determining, based on the historical sensor data, that an individual entered the first region of the physical space at a second point in time subsequent to the first point in time.

Clause 14: The method of any one of Clauses 10-13, wherein learning the label for the first region comprises labeling the first region using the action identifier based on (i) a location of the first region in the physical space and (ii) an action performed by the individual, determined based on the historical sensor data.

Clause 15: The method of any one of Clauses 10-14, wherein the location of the first region corresponds to a defined room, of a set of rooms in the physical space.

Clause 16: The method of any one of Clauses 10-15, wherein the action performed by the individual comprises at least one of: (i) sitting, (ii) standing, (iii) laying down, or (iv) sleeping.

Clause 17: The method of any one of Clauses 10-16, further comprising providing one or more personal services to the individual based on the first user identifier.

Clause 18: A system, comprising: a memory comprising computer-executable instructions; and one or more processors configured to execute the computer-executable instructions and cause the processing system to perform a method in accordance with any one of Clauses 1-17.

Clause 19: A system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or systems (e.g., the sensor system 115 of FIG. 1) or related data available in the cloud. For example, the sensor system could execute on a computing system in the cloud and learn and/or use region information to individualize sensor data. In such a case, the sensor system could access and evaluate sensor data, and store the identified users and actions in the cloud. Doing so allows a user to access this information from any computing system attached to a network connected to the cloud (e.g., the Internet).

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving sensor data indicating presence of an individual in a physical space;
identifying a defined set of regions of the physical space;
identifying, based on the sensor data, a first region, of the defined set of regions, where the individual is located;
labeling the sensor data with a user identifier, of a plurality of user identifiers associated with the physical space, based on the first region; and
providing one or more personal services to the individual based on the user identifier.

2. The method of claim 1, wherein the sensor data comprises radar data collected using one or more radar sensors in the physical space.

3. The method of claim 1, wherein the first region is labeled with the user identifier to indicate that a user corresponding to the user identifier is associated with the first region in the physical space.

4. The method of claim 1, wherein identifying the defined set of regions comprises:
identifying one or more manually defined regions in the physical space; and
identifying, for each respective region of the one or more manually defined regions, a respective manually defined user identifier.

5. The method of claim 1, wherein identifying the defined set of regions comprises, for at least one region of the defined set of regions, learning a user identifier associated with the at least one region based on historical sensor data for the physical space.

6. The method of claim 1, further comprising assigning a completed action to a user corresponding to the user identifier based on the first region.

7. The method of claim 6, wherein assigning the completed action to the user comprises identifying one or more action identifiers having a manually defined association with the first region.

8. The method of claim 6, wherein assigning the completed action to the user comprises learning one or more action identifiers associated with the first region based on historical sensor data.

9. The method of claim 1, wherein the one or more personal services comprise one or more healthcare-related services selected to allow the individual to reside in the physical space.

10. A method, comprising:
receiving historical sensor data indicating, for one or more prior times, presence of an individual in a first region of a physical space;
learning a label for the first region based on the historical sensor data, comprising at least one of (i) labeling the first region using a first user identifier corresponding to a first user, or (ii) labeling the first region using an action identifier;
receiving current sensor data indicating presence of an individual in the physical space; and
in response to determining, based on the current sensor data, that the individual is in the first region, labeling the current sensor data with at least one of (i) the first user identifier or (ii) the action identifier.

11. The method of claim 10, wherein the historical sensor data and current sensor data comprise radar data collected using one or more radar sensors in the physical space.

12. The method of claim 10, wherein learning the label for the first region comprises labeling the first region using the first user identifier in response to determining, based on the historical sensor data, that the first user has a stronger association with the first region, as compared to at least a second user.

13. The method of claim 12, wherein determining that the first user has the stronger association comprises:
determining, based on the historical sensor data, that an individual left a second region of the physical space at a first point in time, wherein the second region is labeled using the first user identifier; and
determining, based on the historical sensor data, that an individual entered the first region of the physical space at a second point in time subsequent to the first point in time.

14. The method of claim 10, wherein learning the label for the first region comprises labeling the first region using the action identifier based on (i) a location of the first region in the physical space and (ii) an action performed by the individual, determined based on the historical sensor data.

15. The method of claim 14, wherein the location of the first region corresponds to a defined room, of a set of rooms in the physical space.

16. The method of claim 14, wherein the action performed by the individual comprises at least one of: (i) sitting, (ii) standing, (iii) laying down, or (iv) sleeping.

17. The method of claim 10, further comprising providing one or more personal services to the individual based on the first user identifier.

18. A non-transitory computer-readable storage medium comprising computer-readable program code that, when executed using one or more computer processors, performs an operation comprising:
receiving sensor data indicating presence of an individual in a physical space;
identifying a defined set of regions of the physical space;
identifying, based on the sensor data, a first region, of the defined set of regions, where the individual is located;
labeling the sensor data with a user identifier, of a plurality of user identifiers associated with the physical space, based on the first region; and
providing one or more personal services to the individual based on the user identifier.

19. The non-transitory computer-readable storage medium of claim 18, wherein identifying the defined set of regions comprises, for at least one region of the defined set of regions, learning a user identifier associated with the at least one region based on historical sensor data for the physical space.

20. The non-transitory computer-readable storage medium of claim 18, the operation further comprising assigning a completed action to a user corresponding to the user identifier based on the first region.
